(19) United States
(12) Patent Application Publication
(10) Pub. No.: US 2009/0050378 A1
(43) Pub. Date: Feb. 26, 2009

(54) STYLUS AND PORTABLE ELECTRONIC DEVICE USING THE SAME

(75) Inventor: WEI-LUNG LEE, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignee: CHI MEI COMMUNICATION SYSTEMS, INC., Tu-Cheng City (TW)

(21) Appl. No.: 11/967,019

(22) Filed: Dec. 29, 2007

(30) Foreign Application Priority Data
Aug. 20, 2007 (CN) 200710201410.2

(51) Int. Cl. G06F 3/033

(52) U.S. Cl. 178/19.01

(57) ABSTRACT

A stylus (20) includes a stylus body, a writing portion (24) and a flexing member (22). The writing portion is connected with one end of the stylus body. The flexing member is connected with the other end of the stylus body. The flexing member is extended and compressed by outer force.

### BACKGROUND OF THE INVENTION

1. Field of the Invention

The present invention relates to styluses, particularly, to a stylus applied to a portable electronic device and a portable electronic device using the same.

2. Description of Related Art

At present, portable electronic devices, such as mobile phones, hand-held computers, laptop computers, and personal digital assistants (PDAs), have become increasingly popular. Many of these portable electronic devices include an electronic stylus or pen, which can be utilized by a user for inputting and/or navigating the user interface of the software application.

Currently, a typical stylus includes a sleeve, a sliding member, a spring, a resisting member and a writing portion. The resisting member and the spring are mounted on both ends of the sliding member. The spring is set in the sleeve. The sliding member is slidably received in one end of the sleeve, and the other end of the sliding member resists the spring. The resisting member has a releasing portion and a latching portion. The releasing portion is provided for easily pulling out the stylus from the receiving groove. The writing portion is connected with the other end of the sleeve, and resists the spring.

A receiving room of the portable device is defined with an open end. The stylus is stored in the receiving room.

However, the typical stylus has a complex structure with many components. The sleeve and the sliding member of the typical stylus are made of stainless steel. Therefore, the manufacture process is complex and the cost is high. Furthermore, stainless steel may interfere the communication of the portable electronic device.

Therefore, a new stylus is desired in order to overcome the above-described problems.

### SUMMARY OF THE INVENTION

In one aspect thereof, a stylus includes a stylus body, a writing portion and a flexing member. The writing portion is connected with one end of the stylus body. The flexing member is connected with the other end of the stylus body. The flexing member can be extended and compressed by outer force.

In another aspect thereof, a portable electronic device includes a main body, a touch screen and a stylus. The touch screen is provided on the main body. The stylus is provided for inputting information and navigating the user interface of the software application. The stylus includes a stylus body, a writing portion and a flexing member. The writing portion is connected with one end of the stylus body and provided for inputting information on the touch screen. The flexing member is connected with the other end of the stylus body. The flexing member can be extended or compressed by outer force. A receiving groove is defined in the main body for receiving the stylus therein.

Other advantages and novel features will become more apparent from the following detailed description when taken in conjunction with the accompanying drawings.

### BRIEF DESCRIPTION OF THE DRAWINGS

Many aspects of the stylus can be better understood with reference to the following drawings. The components in the drawings are not necessarily drawn to scale, the emphasis instead being placed upon clearly illustrating the principles of the present stylus. Moreover, in the drawings, like reference numerals designate corresponding parts throughout the several views.

FIG. 1 is an isometric, exploded view of a stylus, in accordance with an embodiment of the present invention.

FIG. 2 is a front elevational view of a flexing member of the stylus shown in FIG. 1.

FIG. 3 is a front elevational view of the flexing member of the stylus shown in FIG. 1, showing in an extended state.

FIG. 4 is an isometric, assembled view of the stylus shown in FIG. 1.

FIG. 5 is an partially cut-away view of a portable electronic device with the stylus shown in FIG. 4.

FIG. 6 is similar to FIG. 5, but showing the stylus being taken out of the portable electronic device.

FIG. 7 is an isometric view of the portable electronic device shown in FIG. 5, showing the stylus in use.

### DETAILED DESCRIPTION OF THE INVENTION

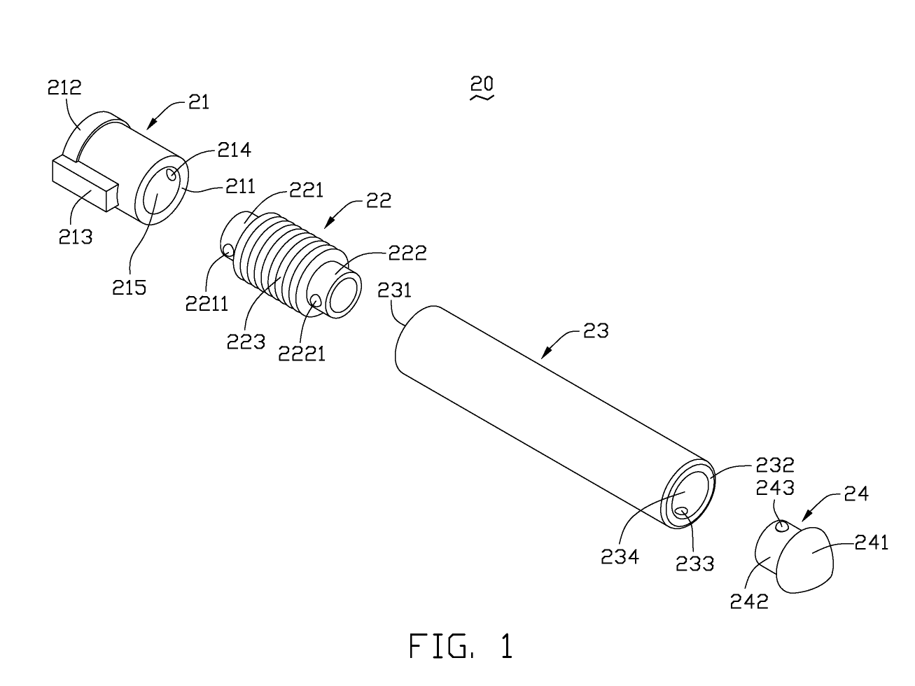

Referring to FIG. 1, a stylus 20 includes a head 21, a flexing member 22, a stylus body 23 and a writing member 24. The stylus body 23 in the present embodiment is a sleeve 23. One end of the flexing member 22 is connected with the head 21, and the other end is connected with the sleeve 23. The writing member 24 and the flexing member 22 are connected with both ends of the sleeve 23.

The head 21 is a hollow cylinder with an open end 211, an close end 212 and a receiving space 215. A pressing portion 213 is provided on an outer periphery of the head 21 adjacent to the close end 212. The pressing portion 213 is a rectangular block made of rubber. Two first latching holes 214 are symmetrically defined in an inner periphery of the head 21 adjacent to the open end 211. Most part of the head 21 except the pressing portion 213 is made of plastic. The head 21 is formed by dual-material injection molding.

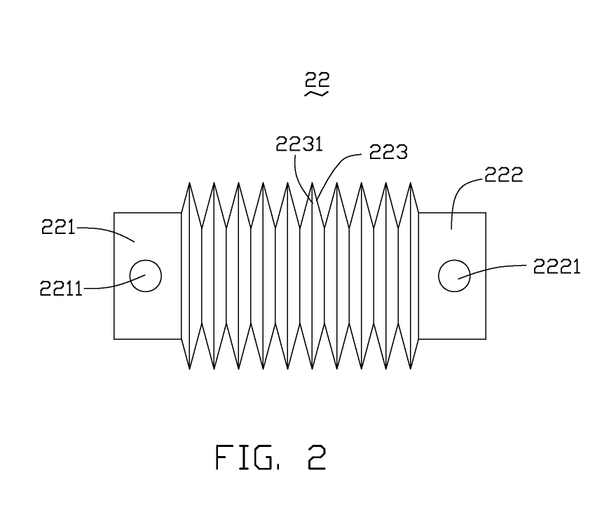

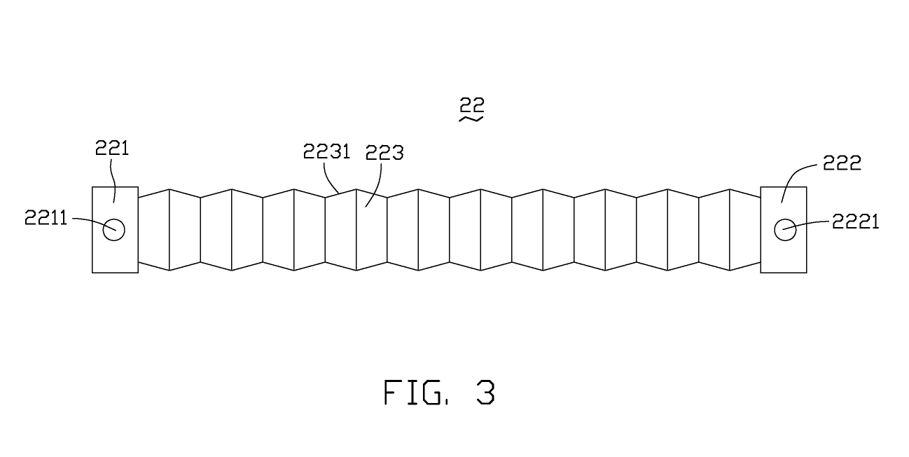

Also referring to FIGS. 2 to 4, the flexing member 22 is a hollow tube with a first end portion 221, a second end portion 222 and a flexing portion 223. The first end portion 221 is a hollow cylinder. Two first latching blocks 2211 symmetrically protrude on the periphery of the first end portion 221 corresponding to the first latching holes 214 in the head 21. An outer diameter of the first end portion 221 is approximately equal to an inner diameter of the head 21. The first end portion 221 is configured for being receivable in the receiving space 215 of the head 21, and the two first latching blocks 2211 are configured for being respectively embeddable in a corresponding first latching hole 214, so that the flexing member 22 is fixed with the head 21.

A shape of the second end portion 222 is same with the shape of the first end portion 221. Two second latching blocks 2221 symmetrically protrude on the outer periphery of the second end portion 222.

The flexing portion 223 is an extendable and compressible tube with a plurality of tube sections 2231 connected together thereof. Each of the tube sections 2231 is a segmented column. The outer diameter of the middle part of the tube section 2231 is larger than both ends thereof. The tube sections 2231 are made of plastic and can keep in a compressed state or an extended state when being compressed or extended by outer force. The tube sections 2231 can be also recovered to an original shape thereof by another outer force.

The sleeve 23 is a hollow cylinder with an first end 231, an second end 232 and a cavity 234. Two second latching holes (not shown) are symmetrically defined in an inner periphery of the sleeve 23 adjacent to the first end 231. The two second latching holes corresponds with the two second latching blocks 2221 of the flexing member 22. An inner diameter of the sleeve 23 is approximately equal to an outer diameter of the second end portion 222. The second end portion 222 is received in the cavity 234 of the sleeve 23, and the two second latching blocks 2221 are respectively embedded in a corresponding second latching hole, so that the flexing member 22 is fixed with the sleeve 23.

Two third latching holes 233 are symmetrically defined in the inner periphery of the sleeve 23 adjacent to the second end 232. The third latching holes 233 are provided for fixing the writing portion 24 with the second end 232 of the cavity 234. The sleeve 23 is made of plastic, such as acrylonitrile butadiene styrene or polycarbonate, and so on.

The writing portion 24 includes a pen tip 241 and a connecting portion 242 connected the pen tip 241 with the sleeve 23. The pen tip 241 is approximately taper-shaped and made of wearable rubber, such as polyoxymethylene. The connecting portion 242 is shaped as cylinder, and the diameter thereof is less than that of the bottom of the pen tip 241. Two third latching blocks 2411 symmetrically protrude on the outer periphery of the connecting portion 242 corresponding to the third latching holes 233 in the sleeve 23.

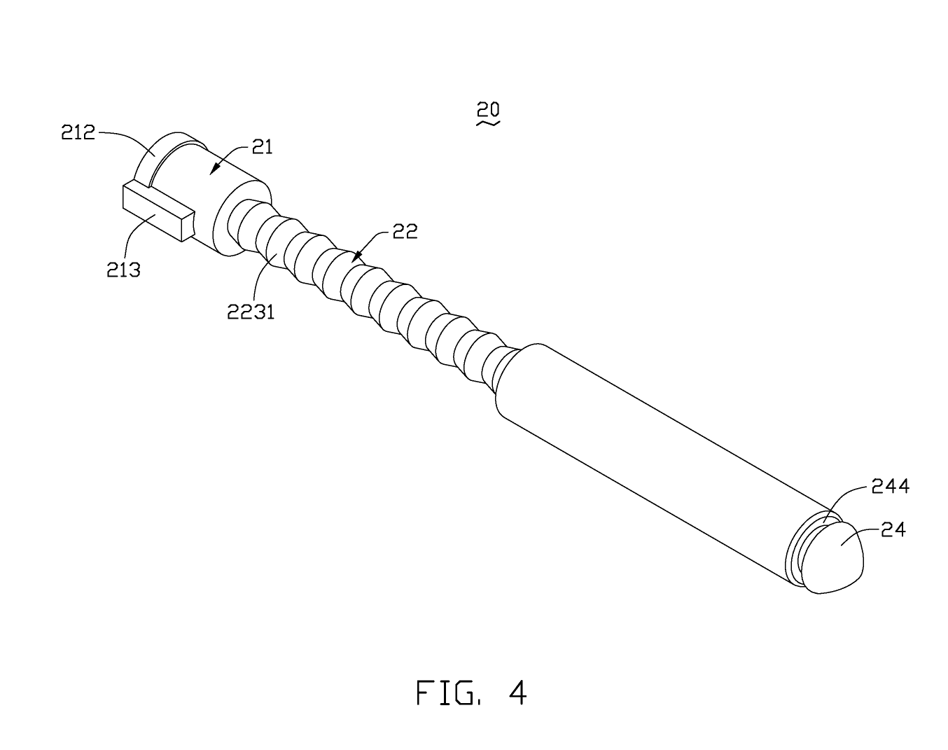

Now referring to FIG. 1 and FIG. 4, in assembly, the first end portion 221 of the flexing member 22 is received in the receiving space 215 of the head 21. The first latching blocks 2211 of the first end portion 221 are embedded in the first latching holes 214 of the head 21. The second end portion 222 of the flexing member 22 is received in the cavity 234 of the sleeve 23 in the first end 231 of the sleeve 23. The second latching blocks 2221 of the second end portion 222 are embedded in the second latching holes of the sleeve 23. The connecting portion 242 of the writing portion 24 is received in the cavity 234 of the sleeve 23 in the second end 232 of the sleeve 23. The third latching blocks 243 of the writing portion 24 are embedded in the third latching holes 233 of the sleeve 23. A latching slot 244 is defined by the second end 232 of the sleeve 23, the connecting portion 242 and the pen tip 241 between sleeve 23 and the pen tip 241. The stylus 20 is assembled as shown in FIG. 4.

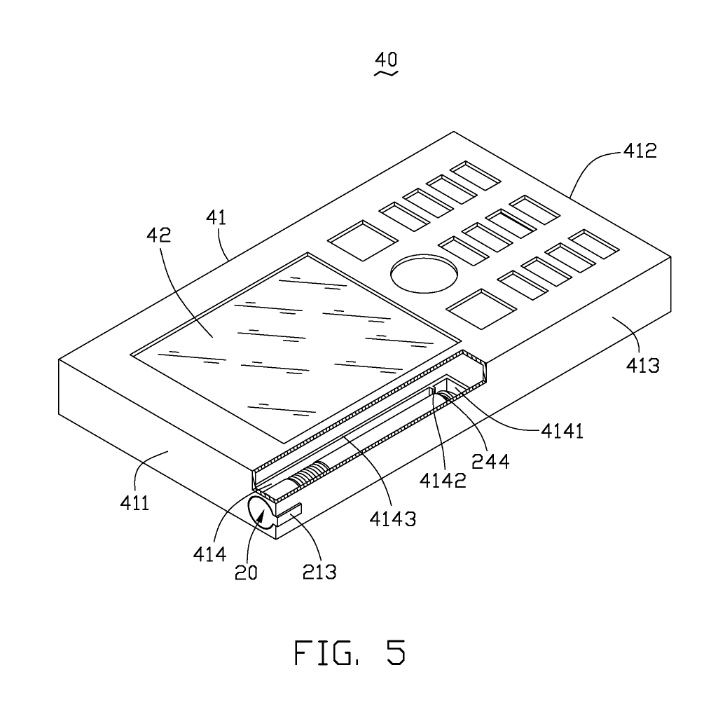

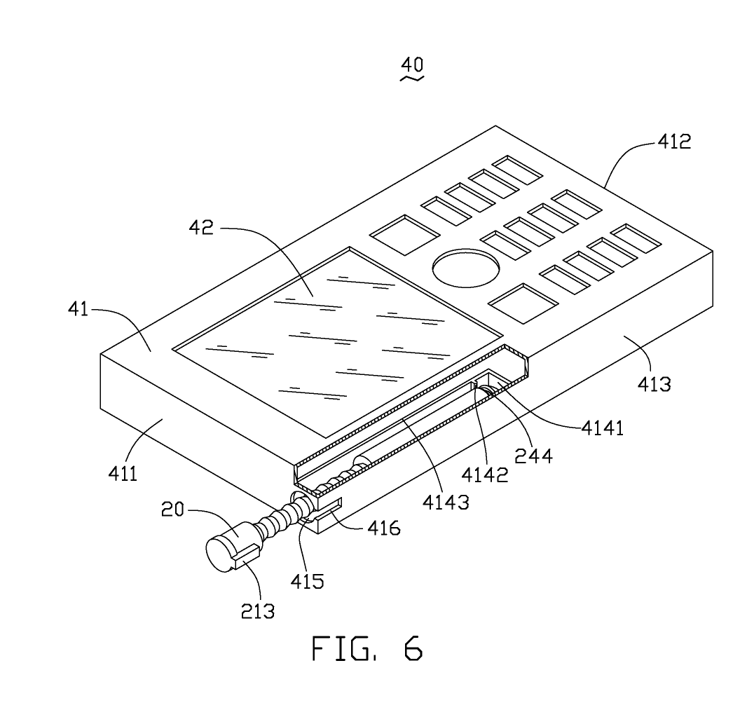

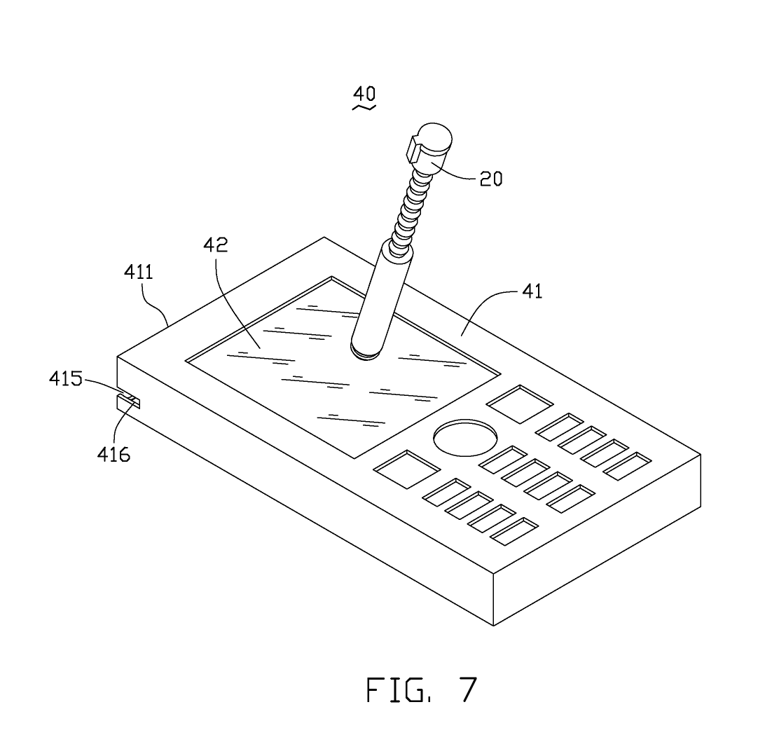

Referring to FIGS. 5 to 7, a portable electronic device 40 includes a main body 41, a touch screen 42 provided on the main body 41, and the stylus 20 provided for inputting information. The main body 41 includes a top wall 411, a bottom wall 412 and a sidewall 413 connecting the top wall 411 and the bottom wall 412. A receiving groove 414 is defined in the top wall 411 adjacent to the sidewall 413. The receiving groove 414 is defined with a base 4141 and an inner wall 4143. A through hole 415 is defined in the top wall 411 corresponding to the receiving groove 414. A notch 416 is defined in the sidewall 413 and communicates with the through hole 415. The notch 416 is provided for receiving the pressing portion 213. A latching protrusion 4142 is formed on the inner wall 4143. The latching protrusion 4142 is provided for cooperating with the latching slot 244 of the stylus 20.

When the stylus 20 needs to be received in the receiving groove 414 of the portable electronic device 40, the stylus 20 is inserted into the receiving groove 414 through the through hole 415 until the pen tip 241 resists the latching protrusion 4142. The pressing portion 213 is pressed to compress the tube sections 2231 of the flexing member 222. Now the open end 211 of the head 21 is near the through hole 415. The pressing portion 213 is continuously pressed to make the pen tip 241 passes over the latching protrusion 4142. The pressing portion 213 is received in the notch 416 and partly exposed out of the sidewall 413 of the portable electronic device 40. The latching protrusion 4142 is inserted into the latching slot 244 and resists the stylus 20. The stylus 20 is completely received in the receiving groove 414 as shown in FIG. 5.

When the stylus 20 needs to be taken out from the receiving groove 144 of the portable electronic device 40, the pressing portion 213 is pressed, and the head 21 is pulled out from the through hole 415. The flexing portion 223 is then extended to a longest state. The stylus 20 is pulled continuously until the latching protrusion 4142 disengages from the latching slot 244. The stylus 20 is completely taken out from the receiving groove 144 of the portable electronic device 40 as shown in FIG. 8.

In use, the best length of the stylus 20 is when the flexing portion 223 is in the longest state. In an alternative embodiment, the flexing member 22 can be connected with the head 21 or the sleeve 23 by glue or threaded connection. The flexing member 22 and the head 21 or the sleeve 23 can also be formed in a single unit. The sleeve 23 can be connected with the writing portion 24 by glue or threaded connection. The sleeve 23 and the writing portion 24 can also be formed in a single unit.

A main advantage of the stylus 20 is that it is made of plastic materials, which reduces cost. Furthermore, the stylus 20 has a simple structure and fewer components.

It is to be further understood that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A stylus comprising:
a stylus body;
a writing portion connected with one end of the stylus body; and
a flexing member connected with the other end of the stylus body, the flexing member is extendable and compressible with an outer force.

2. The stylus as claimed in claim 1, wherein the flexing member includes a flexing portion, the flexing portion is an extendable tube made of a plurality of tube sections connected together, the tube sections are compressible or extendable by outer force.

3. The stylus as claimed in claim 2, wherein the tube sections are made of plastic and can keep in a compressed state or an extended state when being compressed or extended by outer force, the tube sections can also be recovered to an original shape thereof by another outer force.

4. The stylus as claimed in claim 2, wherein the tube sections are made of plastic.

5. The stylus as claimed in claim 2, wherein each of the tube sections is a segmented column, the outer diameter of the middle part thereof is larger than both ends thereof.

6. The stylus as claimed in claim 2, further comprising a head, and a first latching hole is defined in one end of a periphery of the head, the flexing member including a first end portion, a first latching block protruding from the outer periphery of the first portion corresponding to the first latching hole.

7. The stylus as claimed in claim 6, wherein the flexing member further includes a second end portion provided in the other end of the flexing portion, a second latching block is formed on an outer periphery of the second end portion; the stylus body includes a sleeve, a second latching hole is defined in one end of the inner periphery of the sleeve corresponding to the second latching block.

8. The stylus as claimed in claim 7, wherein the writing portion includes a pen tip and a connecting portion, the connecting portion connects the pen tip with the stylus body.

9. The stylus as claimed in claim 8, wherein the connecting portion is shaped in cylinder, two third latching holes are symmetrically defined in the other end of the inner periphery of the sleeve, and two third latching blocks symmetrically protrude from the outer periphery of the connecting portion corresponding to the third latching holes in the sleeve.

10. The stylus as claimed in claim 1, further comprising a head, the head is a hollow cylinder, and a pressing portion protrudes on an outer periphery of the head.

11. The stylus as claimed in claim 10, wherein the pressing portion of the head is made of rubber, the other part of the head is made of plastic, the head is formed by dual-material injection molding.

12. A portable electronic device comprising:
a main body;
a touch screen provided on the main body; and
a stylus provided for inputting information, the stylus comprising:
a stylus body;
a writing portion connected with one end of the stylus body, the writing portion is provided for inputting information on the touch screen; and
a flexing member connected with the other end of the stylus body, the flexing member is extendable and compressible by an outer force;
wherein a receiving groove is defined in the main body for receiving the stylus therein.

13. The portable electronic device as claimed in claim 12, wherein the flexing member includes a flexing portion, the flexing portion is a extendable tube provided with a plurality of tube sections connected together, and the tube sections are extendible and compressible by outer force.

14. The portable electronic device as claimed in claim 13, wherein the tube sections are made of plastic and can keep in a compressed state or an extended state when being compressed or extended by outer force, the tube sections can also be recovered to an original shape thereof by another outer force.

15. The portable electronic device as claimed in claim 13, wherein the tube sections are made of plastic.

16. The portable electronic device as claimed in claim 13, wherein each of the tube sections is a segmented column, the outer diameter of the middle part thereof is larger than both ends thereof.
